(19) United States
(12) Patent Application Publication
(10) Pub. No.: US 2010/0257181 A1
(43) Pub. Date: Oct. 7, 2010

(54) Dynamic Hash Table for Efficient Data Access In A Relational Database System

(75) Inventors: Panfeng ZHOU, Pleasanton, CA (US); Katsunori TERADA, Pleasanton, CA (US); Yanhong WANG, Dublin, CA (US)

Correspondence Address: Sterne, Kessler, Goldstein & Fox P.L.L.C., 1100 New York Avenue, N.W., Washington, DC, 20005, US

(73) Assignee: Sybase, Inc., Dublin, CA (US)

(21) Appl. No.: 12/416,527

(22) Filed: Apr. 1, 2009

(51) Int. Cl. G06F 12/00; G06F 7/00; G06F 12/10

(52) U.S. Cl. 707/747; 711/216; 711/170; 711/206; 707/E17.045; 711/E12.001; 711/E12.06; 711/E12.002

(57) ABSTRACT

Aspects for achieving efficient data access to data elements in a relational database management system are provided. In a computer-implemented method aspect, the efficient data access occurs by establishing a hash table for data elements of a database in a predetermined continuous space of allocated storage, and optimizing utilization of the hash table during database query operations through linear hashing, wherein extension of the hash table occurs automatically to increase a number of pages in the hash table without discernible interruptions of data access to the data elements.

### BACKGROUND OF INVENTION

1. Field of the Invention

The present invention relates generally to databases and, more specifically, to achieving efficient data access in a relational database system.

2. Description of the Background Art

Computers are very powerful tools for storing and providing access to vast amounts of information. Relational databases are a common mechanism for storing information on computer systems while providing easy access to users. A typical relational database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a relational database management system or RDBMS is typically provided as a software cushion or layer. In essence, the RDBMS shields the database user from knowing or even caring about the underlying hardware-level details. Typically, all requests from users for access to the data are processed by the RDBMS. For example, information may be added or removed from data files, information retrieved from or updated in such files, and so forth, all without user knowledge of the underlying system implementation. In this manner, the RDBMS provides users with a conceptual view of the database that is removed from the hardware level. The general construction and operation of database management systems is well known in the art. See e.g., Date, C., “An Introduction to Database Systems, Seventh Edition”, Part I (especially Chapters 1-4), Addison Wesley, 2000.

Efficient data access is one of the properties provided by a database management system. A highly common mechanism to achieve this goal is to associate an index with a large, randomly accessed data file on secondary storage. In essence, the index provides an auxiliary data structure in order to assist in speeding up record retrieval. Indexes are usually implemented as multi-level tree structures, typically maintained as a B-tree data structure.

A key challenge faced by relational database systems is the ever-growing database size. As database sizes have grown from gigabytes to terabytes to petabytes, B-trees contain more metadata pages (i.e., index pages). The data set can grow so large that metadata pages begin to dominate the memory/cache for the B-tree access method. If this happens, the B-tree can be forced to do an I/O (input/output) operation on the secondary storage for each data request, because the probability that any particular data page is already in the cache becomes quite small. Secondary storage accesses are much slower than local memory/cache accesses and thus unfavorable to fast data retrieval.

Accordingly, a need exists for a database access method that provides efficient data retrieval in increasingly large database systems. The present invention addresses such a need.

### SUMMARY OF INVENTION

Embodiments of the invention include aspects for achieving efficient data access to data elements in a relational database management system. In a computer-implemented method aspect, the efficient data access occurs by establishing a hash table for data elements of a database in a predetermined continuous space of allocated storage, and optimizing utilization of the hash table during database query operations through linear hashing, wherein extension of the hash table occurs automatically to increase a number of pages in the hash table without discernible interruptions of data access to the data elements.

Through the dynamic hash table of the present invention, improved data access performance is achieved, particularly for those tables that are primarily used for equality look-ups (i.e., point query), since the dynamic hash table does not need index pages. With the improvements in point query performance, all other queries based on point query are improved. Additionally, by reserving a certain amount of space in each original data page of the dynamic hash table, better collision avoidance is provided for optimized table utilization. Furthermore, linear hash is adapted to provide online (i.e., continuous) service without periodic maintenance interrupts. Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a general block diagram of a computer system in which software-implemented processes of the present invention may be embodied.

FIG. 2 illustrates the general structure of a client/server database system suitable for implementing the present invention.

FIG. 3 illustrates a block flow diagram of a process for achieving efficient data access in a database system with the utilization of a dynamic hash table in accordance with an embodiment of the present invention.

FIG. 4 illustrates a storage layout of a dynamic hash table in accordance with an embodiment of the present invention.

FIG. 5a, 5b, 5c, and 5d illustrate an example of linear hashing to dynamically extend a hash table in accordance with an embodiment of the present invention.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Linux, Solaris, UNIX, IBM AIX, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method act and an apparatus element for performing the method act. Depending upon the implementation, the corresponding apparatus element may be configured in hardware, software, firmware, or combinations thereof.

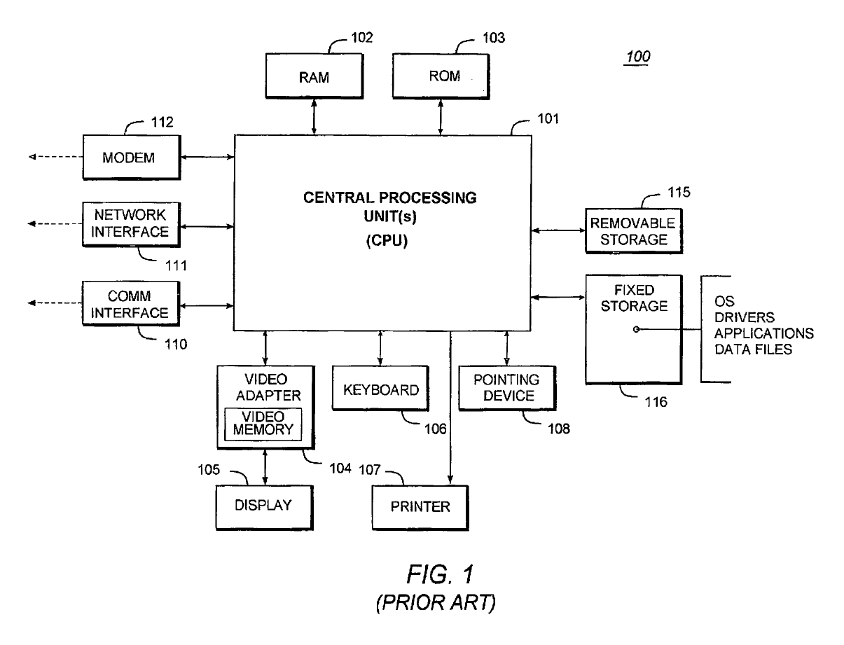

The present invention may be implemented on a conventional or general-purpose computer system, such as an IBM-compatible personal computer (PC) or server computer. FIG. 1 illustrates a general block diagram of a computer system (e.g., an IBM-compatible system) in which software-implemented processes of the present invention may be embodied. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real time system clock is included with the system 100, in a conventional manner.

CPU 101 comprises any suitable processor, such as a processor of the Intel Pentium family of microprocessors, for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components, as is well understood in the art. Random-access memory 102 serves as the working memory for the CPU 101. In a typical configuration, RAM of multiple megabytes or gigabytes is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, a HP Laserjet printer (available from Hewlett Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 100. The software system, which is usually stored in system memory (RAM) 102 and on fixed storage (e.g., hard disk) 116, includes a kernel or operating system (OS) which manages low-level aspects of computer operation, including managing execution of processes, memory allocation, file input and output (I/O), and device I/O. The OS can be provided by a conventional operating system, Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 100. The application(s) or other software intended for use on the computer system may be “loaded” into memory 102 from fixed storage 116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

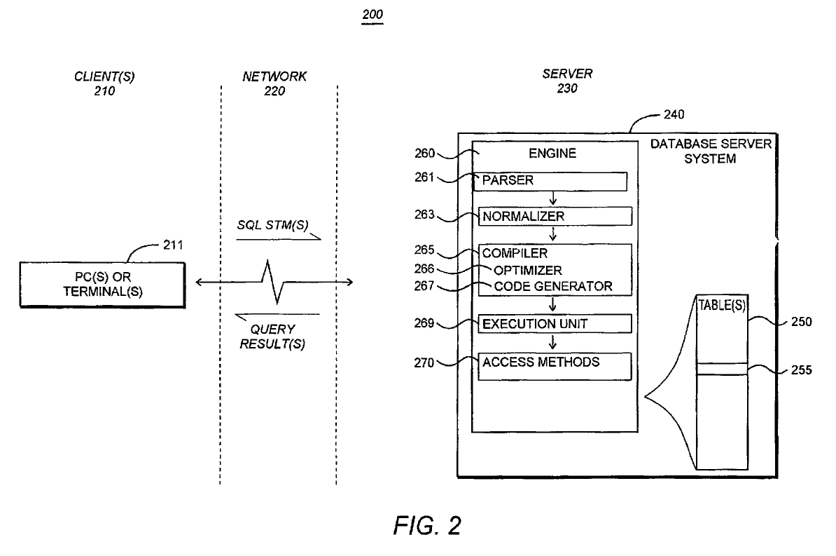

While the present invention may operate within a single (standalone) computer (e.g., system 100 of FIG. 1), the present invention is preferably embodied in a multi-user computer system, such as a client/server system. FIG. 2 illustrates the general structure of a client/server database system 200 suitable for implementing the present invention. (Specific modifications to the system 200 for implementing methodologies of the present invention are described in subsequent sections below.) As shown, the system 200 comprises one or more client(s) 210 connected to a server 230 via a network 220. Specifically, the client(s) 210 comprise one or more standalone terminals 211 connected to a database server system 240 using a conventional network. In an exemplary embodiment, the terminals 211 may themselves comprise a plurality of standalone workstations, dumb terminals, or the like, or comprise personal computers (PCs) such as the above-described system 100. Typically, such units would operate under a client operating system, such as a Microsoft® Windows client operating system (e.g., Microsoft® Windows 95/98, Windows 2000, or Windows XP).

The database server system 240, which comprises Sybase® Adaptive Server® Enterprise (ASE) (available from Sybase, Inc. of Dublin, Calif.) in an exemplary embodiment, generally operates as an independent process (i.e., independently of the clients), running under a server operating system such as Microsoft® Windows NT, Windows 2000, or Windows XP (all from Microsoft Corporation of Redmond, Wash.), UNIX (Novell), Solaris (Sun), or Linux (Red Hat). The network 220 may be any one of a number of conventional network systems, including a Local Area Network (LAN) or Wide Area Network (WAN), as is known in the art (e.g., using Ethernet, IBM Token Ring, or the like). The network 220 includes functionality for packaging client calls in the well-known Structured Query Language (SQL) together with any parameter information into a format (of one or more packets) suitable for transmission to the database server system 240. The described computer hardware and software are presented for purposes of illustrating the basic underlying desktop and server computer components that may be employed for implementing the present invention. For purposes of discussion, the following description will present examples in which it will be assumed that there exist multiple server instances (e.g., database server nodes) in a cluster that communicate with one or more “clients” (e.g., personal computers or mobile devices). The present invention, however, is not limited to any particular environment or device configuration. Instead, the present invention may be implemented in any type of system architecture or processing environment capable of supporting the methodologies of the present invention presented in detail below.

Client/server environments, database servers, and networks are well documented in the technical, trade, and patent literature. In operation, the client(s) 210 store data in, or retrieve data from, one or more database tables 250, as shown at FIG. 2. Data in a relational database is stored as a series of tables, also called relations. Typically resident on the server 230, each table itself comprises one or more “rows” or “records” (tuples) (e.g., row 255 as shown at FIG. 2). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number (SSN), and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of the Structured Query Language (SQL), which is a language allowing users and administrators to create, manipulate, and access data stored in the database. The syntax of SQL is well documented; see, e.g., the above-mentioned “An Introduction to Database Systems”. SQL statements may be divided into two categories: data manipulation language (DML), used to read and write data; and data definition language (DDL), used to describe data and maintain the database. DML statements are also called queries. In operation, for example, the clients 210 issue one or more SQL commands to the server 230. SQL commands may specify, for instance, a query for retrieving particular data (i.e., data records meeting the query condition) from the database table(s) 250. In addition to retrieving the data from database server table(s) 250, the clients 210 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 210 (via network 220) are processed by the engine 260 of the database server system 240. The engine 260 itself comprises a parser 261, a normalizer 263, a compiler 265, an execution unit 269, and an access method 270. Specifically, the SQL statements are passed to the parser 261 which employs conventional parsing methodology (e.g., recursive descent parsing). The parsed query is then normalized by the normalizer 263. Normalization includes, for example, the elimination of redundant data. Additionally, the normalizer 263 performs error checking, such as confirming that table names and column names which appear in the query are valid (e.g., are available and belong together). Finally, the normalizer 263 can also look-up any referential integrity constraints which exist and add those to the query.

After normalization, the query is passed to the compiler 265, which includes an optimizer 266 and a code generator 267. The optimizer 266 performs a cost-based analysis for formulating a query execution plan that is reasonably close to an optimal plan. The code generator 267 translates the query execution plan selected by the query optimizer 266 into executable form for execution by the execution unit 269 using the access methods 270.

All data in a typical relational database system is stored in pages on a secondary storage device, usually a hard disk. Typically, these pages may range in size from 1 Kb to 32 Kb, with the most common page sizes being 2 Kb and 4 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages that have been read from disk reside is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. This can be done by using data structures and algorithms that maximize the use of pages that are known to reside in the cache. Alternatively, it can be done by being more selective about what pages are loaded into the cache in the first place. An additional consideration with respect to I/O is whether it is sequential or random. Due to the construction of hard disks, sequential I/O is much faster then random access I/O. Data structures and algorithms encouraging the use of sequential I/O can realize greater performance.

The present invention improves I/O performance for more efficient query processing, particularly point query (exact match) processing, from an access method utilizing a dynamic hash table (DHT) data structure. The following terms are offered for purposes of illustration, not limitation, in order to assist with understanding the discussion that follows.

Hash Function: refers to any well-defined procedure or mathematical function which converts a large, possibly variable-sized amount of data into a small datum, usually a single integer that may serve as an index into an array.

Hash Key: refers to the column whose value will be used as input for hash function for look-up (e.g., SSN, name).

Hash Key Value: refers to the value of hash key (column).

Hash Value: refers to the value returned by hash function for a given hash key (e.g., the name associated with the SSN).

Collision: refers to more than one hash key value having the same hash value.

Hash Table: refers to a table that contains a set of pages that further contains data entries that can be directly accessed via a hash function. Hash table does not contain any index page.

Dynamic Hash Table (DHT): refers to a hash table whose size can be extended as the size of data set increases.

Hash Region: refers to a set of data pages allocated to a hash table that contains hashed data rows. Hash function evenly distributes data rows across the hash region. The hash region is pre-allocated. Data pages in a hash region need to be continuous for simplicity of mapping from hash value to page number in a hash region, and for performance of mapping.

Original page: refers to data pages that can be directly accessed via the hash function in a hash table. They are pre-allocated. All data pages in a hash region are original pages.

Overflow page: refers to a page that will be created to hold the overflow data and linked with the original page when the original page cannot hold the data. The overflow page is not necessarily to be pre-allocated.

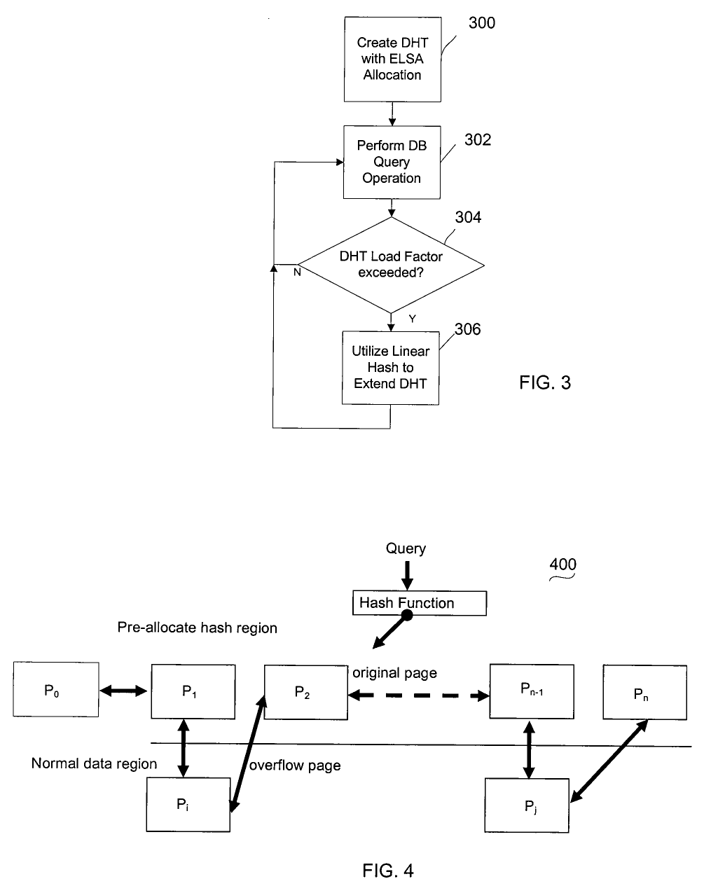

Referring to the block diagram of FIG. 3, in accordance with an embodiment of the present invention, efficient query processing initiates with the creation of a dynamic hash table (DHT) (block 300). In terms of the DDL, the creation results from an extension to known create table syntax via a hash cluster clause similar to that used currently for a partition clause. For example,

create table [database .[owner ].]table_name ......[ hash_cluster_clause ]
Hash_cluster_clause::= [[CONSTRAINT constraint_name]
{UNIQUE | PRIMARY KEY}]
HASH CLUSTERED (column_name [{, column_name} ... ])
WITH HASHVALUES = number_of_hash_values
[, SIZE = bytes_per_row ]
[, RESERVERATE = percentage_of_reserve_space]

where CONSTRAINT introduces the name of an unique or primary key constraint which is defined on hash key column(s) in the DHT,

constraint_name is the name of an unique or primary key constraint on hash key column(s) in the DHT,

UNIQUE constrains the values in the indicated column(s) so that no two rows have the same value. This constraint does not create any index and is enforced by the hash key in the DHT.

PRIMARY KEY constrains the values in the indicated column(s) so that no two rows have the same value, and so that the value cannot be NULL. This constraint does not create any index and is enforced by the hash key in DHT.

HASH CLUSTERED indicates that this table is DHT.

column_name when used in the hash cluster clause, specifies a hash key column. Users can hash by a set of columns and those columns can be any data type. Duplicate hash key value is allowed, but it will deter the performance of DHT.

HASHVALUES=number_of_hash_values specifies the number of distinguished hash values in the hash table when it is created.

SIZE=bytes_per_row specifies the number of bytes each data row will occupy (e.g., median size of data row). If a user does not specify it, the maximum size of data row is used (e.g., varchar(100) will count for 100 bytes).

RESERVERATE=percentage_of_reserve_space specifies the percentage of space in each data page that will be reserved for collision, as described further hereinbelow. If a user does not specify it, 0% space will be reserved for potential conflict data entries.

For example,

Create table order_line (id int, age int, name varchar(100),
Hash clustered (id, age)
With Hashvalues=10000,
Size=30,
Reserverate=20 )

would create a table that is hashed by id and age (both of type integer (int)). The expected row size is 30 bytes (if “size” is not specified, 108 bytes (4+4+100) will be used instead) and 10000 hash values are reserved. 20% space in each page is reserved for conflict data entries. If page size is 2K, 53 slots will be mapped to each data page by the hash function.

The performance of the hash table heavily depends on how the collisions are handled. ASE DHT uses the following two methods to avoid extra I/O that might be caused by collision.

First, in a preferred embodiment, data records are mapped to a specific page instead of a slot within a page. Thus, there is no need to allocate an overflow page as long as the original page can still hold all data entries, so that each page can absorb some collision without using an overflow page, which might further cause extra I/O for later retrievals. For example, suppose a first data entry whose hash column value is “Tony” is saved in the first data slot in a page, and a second data entry whose hash column value is “Terada” has the same hash value. If each data entry is mapped to a specific slot in a specific page, then the second data entry would map to the same slot as “Tony”. Since the first slot has already been occupied, an overflow page P′ would be needed and all retrieval afterward might need to access the overflow page (P′). In the present invention, however, the insertion of the second data entry will not cause the creation of overflow page P′, since it will be saved in the second data slot in the page.

Secondly, certain space in each original page will be reserved to store extra data entries that might be introduced by collision, and users can specify this parameter when they create a DHT. For example, if each original data page can store 50 data entries and reservation rate is 20 (i.e., reserverate=20), then only 40 data entries will be mapped to one original page. Each original page can store 10 more extra data entries that might be introduced by collision. Hence, overflow pages are less likely to be created and less extra I/O will be used for data retrieval.

In creating the DHT, a predetermined continuous space of allocated storage having extremely large scale (e.g., GB, gigabyte) is provided. In an exemplary embodiment of the present invention, extremely large scale allocation (ELSA) results by extending the use of the page allocation mechanism from the alter database command in Sybase ASE so as to avoid locking the whole database and to guarantee the fast allocation of extremely large continuous space. It should be appreciated that although this description refers to the functionality of ASE, this is meant as illustrative and not restrictive. Thus, techniques that are suitable to provide the described ELSA may be employed as appropriate. More details are illustrated as follows.

In ASE, system table “sysdevices” contains one row for each tape dump device, disk dump device, disk for databases, and disk partition for databases, and system table “sysusages” contains one row for each disk allocation piece assigned for a database. ELSA will open these two tables and find free continuous disk space assigned to a database on disk devices. Then ELSA marks the space as occupied by a DHT.

ELSA can be much faster than the normal page allocation mainly for two reasons:

1. It makes use of the large I/O subsystem as pages are allocated contiguously. In modern computer system, sequential I/O to the continuous disk space can be roughly 10-30 times faster than random I/O to random disk space.

2. It decreases the logging activity. Normal page allocation needs one log record for each page allocation. In ELSA, only one log record is needed for page allocation no matter how many pages (e.g., thousands, millions, etc) are allocated. The huge amount of time to construct log records and flush them to disk can be eliminated.

FIG. 4 illustrates a block diagram representation of a storage layout 400 of a DHT within the allocated space in accordance with a preferred embodiment. Pages P₀ to Pₙ comprise the pre-allocated hash region and overflow data pages Pᵢ, Pⱼ comprise pages allocated in the normal data region that go through normal data page allocation code path, as is commonly understood. It should be appreciated that the storage layout of the DHT allows for sharing of the storage segment with other objects and does not require an exclusive segment.

In operation, the utilization of the stored DHT 400 proceeds with database query operations (block 302, FIG. 3). No syntax changes for the DML (data manipulation language) are needed to utilize the DHT, so that users may use the same DML on DHT as on regular tables. The optimizer (266, FIG. 2) chooses whether or not the hash function will be used, as is well understood to those of skill in the art.

By way of example, in an exemplary embodiment, on an UPDATE query operation, if the EQUI SARGS (equality search arguments) are defined on all of the hash key columns, the target page can be directly calculated based on the hash function. Otherwise, non-cluster index (if it exists) will be used to locate the target page. If there is no non-cluster index, table scan will be used. For table scan, the table scan preferably starts from the first page in the pre-allocated region with all overflow pages also visited. Further, the UPDATE might cause the original page to overflow and create an overflow page. If the UPDATE involves a hash key column change, preferably the data entry will be deleted from the original slot and inserted into another slot based on its new hash value.

For a DELETE in DHT, if the EQUI SARGS are defined on all the key columns, the target page can be directly calculated based on hash function. The original page and its overflow pages (if they exist) will be searched, and the corresponding record will be deleted. Even if there is no page entry in the data page after deletion, the overflow data page in the normal region will be de-allocated while the original data pages in the hash region will not be de-allocated. Otherwise, the non-cluster index will be used to locate the page. If there is no non-cluster index, table scan will be used.

For an exact match or point query operation, if the EQUI SARGS are defined on all the key columns, target page can be directly calculated based on hash function. The original page and its overflow pages (if they exist) will be searched, and the corresponding record will be fetched if it exists. Otherwise, non-cluster index will be used to locate the page. If there is no non-cluster index, table scan will be used.

For an INSERT in the DHT, the target page can be directly calculated based on hash function. If there is an overflow, an overflow data page is allocated in normal data page region. Further, INSERT may result in a need to extend the DHT if the load factor of a DHT reaches the predefined threshold (block 304, FIG. 3, is affirmative). The “load factor” acts as a system configuration variable with application to all DHT created at one database instance and reflects a threshold for the number of data entries that have been inserted in a DHT divided by the total number data entries that could be stored in the DHT (excluding the space reserved at each page and overflow page for collisions). When the threshold is met, the need for extension triggers ELSA for allocation of the appropriate storage space, as well as a linear hash function to increase a number of pages in the hash table without interrupting data access to the data elements (block 306).

Preferably, the insertion and the ELSA are provided as two separate transactions, with ELSA being scheduled as a system transaction, so as to avoid unacceptable delays for users, as may occur if it was done as a sub-transaction, since allocating space will take longer as the DHT grows. Optimization results through the linear hashing, wherein extension of the hash table occurs automatically.

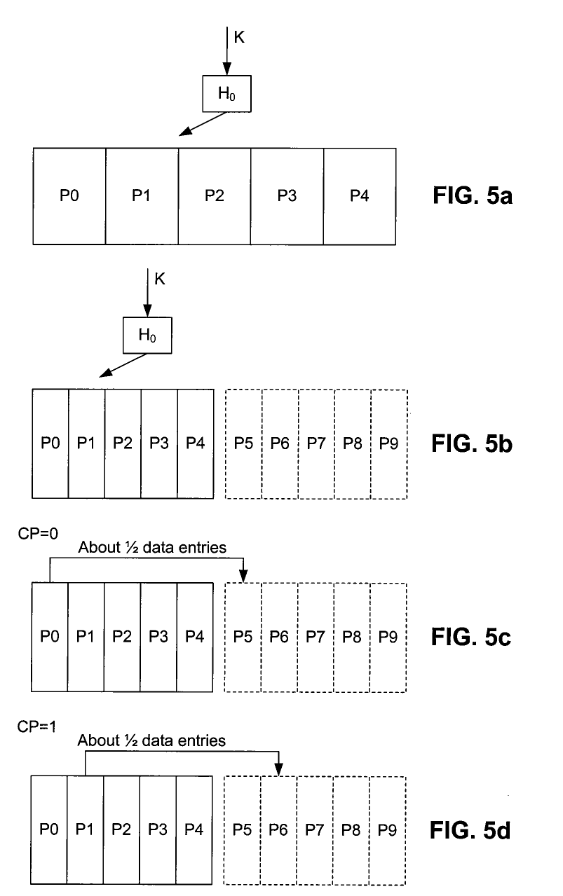

Referring now to FIG. 5a-5d, an example of how a linear hash function can be used to grow a table is presented. As known, general form for the linear hash function is given as Hⱼ(K)=g(K)mod(N*2^{j}), where g(K) is a standard hash function, N is the initial number of pages in the hash region, and j=0, 1, 2, . . . and records the level of the hash function. For example, H₀(K)=g(K)mod N, H₁(K)=g(K)mod 2N. As shown in the example of FIG. 5a, five pages, P0-P4, are allocated initially for a hash table and the hash function is H₀(K)=K mod 5, where K is the hash key that is used, and each page can store 10 records. Given a predetermined load factor of 0.8 (representing a ratio of the number of inserted elements to the number of allocated slots), another five pages, P5-P9 (FIG. 5b), will be allocated when there are 40 data entries in the hash table. To split a page, a new function H₁=K mod 10 is introduced. In this manner, for everything in P0 of the hash table hashed by H₀, about one-half of data entries will stay in P0 and one-half will be in P5 of the table hashed by H₁ (FIG. 5c). A current split pointer (CP), is initialized as 0 and is used to record the next split page. After DHT doubles its space, each following insertion will trigger one page split until all pages in the original hash table have been split, with CP increasing by 1, as represented in FIG. 5d. Locating each hash key occurs by determining the page number (PageNo) according to PageNo=H₀(K), if PageNo<CP, else PageNo=H₁(K). Initially, only H₀(K) is used since CP=0. During page splits, both H₀(K) and H₁(K) are used. After all page splits, H₀(K) will be replaced by H₁(K) and CP is reset to 0, as is well understood by those skilled in the art.

Through the use of linear hash for extending the DHT, the DHT provides uninterrupted service (i.e., there is no need for periodically table re-organization) for continued database operations (block 302, FIG. 3). This avoids known problems with those hash table approaches in which users must create a new hash table, then copy the data from the original hash table, if the size of a hash table become bigger than its original estimated size, during which time, the data in the hash table will be temporally in-accessible, reducing the online time of the data server. In the present invention, however, linear hash is adapted to provide on-line service without discernible interruptions of data access. Experimental evidence indicates that the dynamic hash table approach of the present invention has significantly better performance (up to three times faster) than the known B-tree access approach for exact match/point query operations. Further, because the DHT of the present invention has no metadata pages, the cache has a higher probability of a particular data page being present in the presence of large data sets.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A computer-implemented method to achieve efficient data access to data elements in a relational database management system, the method comprising:
a. establishing a hash table for data elements of a database in a predetermined continuous space of allocated storage; and
b. optimizing utilization of the hash table during database query operations through linear hashing, wherein extension of the hash table occurs automatically to increase a number of pages in the hash table without discernible interruptions of data access to the data elements.

2. The computer-implemented method of claim 1 wherein optimizing further comprises monitoring a predetermined load factor to identify when to automatically increase the number of pages in the hash table.

3. The computer-implemented method of claim 1 wherein optimizing further comprises reserving a predetermined portion of each page in the hash table for collisions.

4. The computer-implemented method of claim 1 further comprising mapping data elements in the hash table based on a page identifier.

5. The computer-implemented method of claim 1 further comprising allocating pages for overflow of the hash table as needed in a data region outside of the allocated storage.

6. The computer-implemented method of claim 1 wherein establishing further comprises utilizing a single command statement to create the hash table.

7. A computer-implemented method to achieve efficient data access to data elements in a relational database management system, the method comprising:
a. creating an index-less hash table from a single command statement and in a predetermined allocation of reserved, continuous storage space;
b. increasing entries as needed in the index-less hash table during database operations based on a load factor; and
c. mapping data elements to an exact page in the index-less hash table through hashing of data column.

8. The computer-implemented method of claim 7 wherein increasing entries further comprises linear hashing.

9. The computer-implemented method of claim 7 wherein a single command statement further comprises a create table statement with a hash cluster clause.

10. The computer-implemented method of claim 7 further comprising reserving a predetermined portion of each page in the index-less hash table for collisions.

11. The computer-implemented method of claim 7 further comprising allocating pages for overflow of the index-less hash table as needed in a data region outside of the predetermined allocation of reserved continuous storage space.

12. A system to achieve efficient data access to data elements in a relational database management system, the system comprising
a. storage means;
b. processing means coupled to the storage means; and
c. database management means coupled to the storage means and controlled by the processing means, the database management means creating a hash table for data elements of a database in a predetermined continuous space of allocated storage having extremely large scale and optimizing utilization of the hash table during database query operations through linear hashing, wherein extension of the hash table occurs automatically to increase a number of pages in the hash table without interrupting data access to the data elements.

13. The system of claim 12 wherein optimizing further comprises monitoring a predetermined load factor to identify when to automatically increase the number of pages in the hash table.

14. The system of claim 12 wherein optimizing further comprises reserving a predetermined portion of each page in the hash table for collisions.

15. The system of claim 12 wherein the database management means further maps data elements in the hash table based on a page identifier.

16. The system of claim 12 wherein the database management further allocates pages for overflow of the hash table as needed in a data region outside of the allocated storage.

17. The system of claim 12 wherein the database management means further creates the hash table based on a single command statement.

18. A computer program product comprising a computer-usable medium having computer program logic recorded thereon for enabling a processor to achieve efficient data access to data elements in a relational database management system, the computer program logic comprising:
database management means for enabling a processor to create a hash table for data elements of a database in a predetermined continuous space of allocated storage having extremely large scale and optimize utilization of the hash table during database query operations through linear hashing, wherein extension of the hash table occurs automatically to increase a number of pages in the hash table without interrupting data access to the data elements.

19. The computer program product of claim 18 wherein creation of the hash table further comprises creation of an index-less hash table from a single command statement.

20. The computer program product of claim 18 wherein utilization of the hash table further comprises mapping the data elements to an exact page through hashing of data column.
